(19) United States
(12) Patent Application Publication
(10) Pub. No.: US 2015/0280757 A1
(43) Pub. Date: Oct. 1, 2015

(54) MULTICARRIER DYNAMIC PREDISTORTION FOR DIGITAL TRANSMISSION

(71) Applicant: Hughes Network Systems, LLC, Germantown, MD (US)

(72) Inventors: Bassel BEIDAS, Alexandria, VA (US); Neal BECKER, Frederick, MD (US)

(21) Appl. No.: 14/675,735

(22) Filed: Mar. 31, 2015

Related U.S. Application Data
(60) Provisional application No. 61/973,227, filed on Mar. 31, 2014.

(51) Int. Cl. H04B 1/04

(52) U.S. Cl. CPC H04B 1/0475

(57) ABSTRACT

An approach for predistorting signals to be transmitted via a multicarrier satellite transponder to account for inter-symbol interference. Multiple source signals are received. A transmit filter model is applied to each source signal to generate a respective filtered signal. Each filtered signal is translated to a carrier frequency, and the translated signals are summed to generate a composite signal. A common non-linearity model is applied to the composite signal to generate a model transmit signal. The transmit signal is translated to generate a receive signal estimate for each of the filtered signals. A receive filter model is applied to each receive estimate to generate a filtered estimate. Each filtered estimate is subtracted from the respective source signal to generate an error sequence. A fraction of the error sequence is added to the respective source signal to generate a predistorted signal for transmission via a multicarrier satellite transponder.

### RELATED APPLICATIONS

This application claims the benefit of the earlier filing date under 35 U.S.C. §119(e) of U.S. Provisional Application Ser. No. 61/973,227 (filed 2014 Mar. 31).

### BACKGROUND

Satellite communication systems must transmit signals vast distances from earth to satellites in orbit and vice versa. Additionally, satellites have strict power consumption limits that require the communication systems to operate at very high efficiencies of both power use and usage of available communication bandwidth. Many satellites use HPAs for communication purposes. Typically, HPAs operate most efficiently at (or near) saturation. Unfortunately, operation of HPAs at (or near) saturation can lead to inter-symbol interference (ISI) in output channels. The output of a transmitter can be seen as a sequence of symbols called a phrase. Each symbol represents a sequence of bits, in the case of 8 PSK, each symbol represents 3 bits. A transmitter will output the phrase one symbol at a time during transmission. As a transmitter shifts from one symbol to the next in the phrase, previous and future output symbols may cause interference in the output of the current symbol. This interference in the current symbol caused by past and future symbols is ISI.

In today's satellite communications systems, the uplinked signal is amplified and channelized in a transparent satellite transponder. Power efficient on-board amplification brings non-linear distortions limiting the usage of spectrally efficient modulation schemes. Additionally, increase in data rates will require higher spectral efficiencies. Further, joint amplification of multiple-carrier signals using a single High-Power Amplifier (HPA) is envisaged due to sharing of satellite capacity among different links and to meet power/mass requirements. The non-linear effects are even more prominent in this scenario due to onset of intermodulation products causing adjacent channel interference (ACI). A significant guard-band between the carriers may be needed in order to avoid ACI, thereby reducing spectral efficiency. Additionally, use of multiple carriers leads to high peak to average power ratios, which increases the back-off leading an amplification efficiency loss. Moreover, on-board channelization filters (IMUX/OMUX) introduce inter-symbol interference (ISI), which further degrades the performance. In order to mitigate the nonlinear distortion, significant back off is required, leading to power efficiency loss. This motivates the need to study techniques to improve power and spectral efficiencies.

What is needed, therefore, is an improved multicarrier satellite communications system, employing an HPA that amplifies a composite multicarrier signal for transmission over a satellite channel, where the HPA is driven at or near saturation.

### BRIEF SUMMARY

The present invention advantageously addresses the foregoing requirements and needs, as well as others, by providing an approach for an improved multicarrier satellite communications system, employing an HPA that amplifies a composite multicarrier signal for transmission over a satellite channel, where the HPA is driven at or near saturation. In accordance with example embodiments, such an improved system is achieved by predistorting the transmitted signals to account for the inter-symbol interference (ISI) that results from the amplification of the composite multicarrier signal. By way of example, the estimated distortion may be based on the current, past and future symbols of output. Further, improved estimates of distortion may be calculated by using several stages of distortion estimation where subsequent stages use estimates of the distortion of current, past and future symbols from the previous stage to refine the estimated distortion of the current symbol.

In accordance with example embodiments a method is provided for predistorting source signals for transmission via a multicarrier satellite transponder to account for the inter-symbol interference (ISI) that results from the amplification of the composite multicarrier signal. A plurality of source signals are received. A transmit filter model is applied to each of the source signals to generate a respective filtered signal for each source signal. Each of the filtered signals is translated to a respective carrier frequency. The translated signals are summed to generate a composite signal. A common non-linearity model is applied to the composite signal to generate a model transmit signal. The transmit signal is translated to generate a receive signal estimate of each of the filtered signals. A receive filter model is applied to each of the receive signal estimates to generate a filtered receive signal estimate. Each filtered receive signal estimate is subtracted from the respective source signal to generate an error sequence for the respective filtered receive signal estimate. A fraction of the error sequence for each filtered receive signal estimate is added to the respective source signal to generate a respective predistorted signal for transmission via a multicarrier satellite transponder.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates a block diagram depicting a transmitter in a multicarrier system, where M_{c} independent source signals are to be transmitted over a single satellite channel;

FIG. 2 illustrates a block diagram depicting the multicarrier transmitter of FIG. 1, employing a multicarrier predistorter, in accordance with example embodiments of the present invention;

FIG. 3 illustrates a block diagram depicting an M^{th} stage of the multicarrier successive predistorter 200 of FIG. 2, for a one of the M_{c} signals, in accordance with example embodiments of the present invention; and

FIG. 4 illustrates a block diagram depicting a multicarrier dynamic predistorter, in accordance with example embodiments of the present invention.

### DETAILED DESCRIPTION

Approaches for an improved multicarrier satellite communications system, employing an HPA that amplifies a composite multicarrier signal for transmission over a satellite channel, where the HPA is driven at or near saturation, are described. In the following description, for the purposes of explanation, numerous specific details are set forth in order to provide a thorough understanding of the present invention. The present invention is not intended to be limited based on the described embodiments, and various modifications will be readily apparent. It will be apparent that the invention may be practiced without the specific details of the following description and/or with equivalent arrangements. Additionally, well-known structures and devices may be shown in block diagram form in order to avoid unnecessarily obscuring the invention. Further, the specific applications discussed herein are provided only as representative examples, and the principles described herein may be applied to other embodiments and applications without departing from the general scope of the present invention.

As will be appreciated, a module or component (as referred to herein) may be composed of software component(s), which are stored in a memory or other computer-readable storage medium, and executed by one or more processors or CPUs of the respective devices. As will also be appreciated, however, a module may alternatively be composed of hardware component(s) or firmware component(s), or a combination of hardware, firmware and/or software components. Further, with respect to the various example embodiments described herein, while certain of the functions are described as being performed by certain components or modules (or combinations thereof), such descriptions are provided as examples and are thus not intended to be limiting. Accordingly, any such functions may be envisioned as being performed by other components or modules (or combinations thereof), without departing from the spirit and general scope of the present invention. Moreover, the methods, processes and approaches described herein may be processor-implemented using processing circuitry that may comprise one or more microprocessors, application specific integrated circuits (ASICs), field programmable gate arrays (FPGAs), or other devices operable to be configured or programmed to implement the systems and/or methods described herein. For implementation on such devices that are operable to execute software instructions, the flow diagrams and methods described herein may be implemented in processor instructions stored in a computer-readable medium, such as executable software stored in a computer memory store.

Further, terminology referring to computer-readable media or computer media or the like as used herein refers to any medium that participates in providing instructions to the processor of a computer or processor module or component for execution. Such a medium may take many forms, including but not limited to non-transitory non-volatile media and volatile media. Non-volatile media include, for example, optical disk media, magnetic disk media or electrical disk media (e.g., solid state disk or SDD). Volatile media include dynamic memory, such random access memory or RAM. Common forms of computer-readable media include, for example, floppy or flexible disk, hard disk, magnetic tape, any other magnetic medium, CD ROM, CDRW, DVD, any other optical medium, random access memory (RAM), programmable read only memory (PROM), erasable PROM, flash EPROM, any other memory chip or cartridge, or any other medium from which a computer can read data.

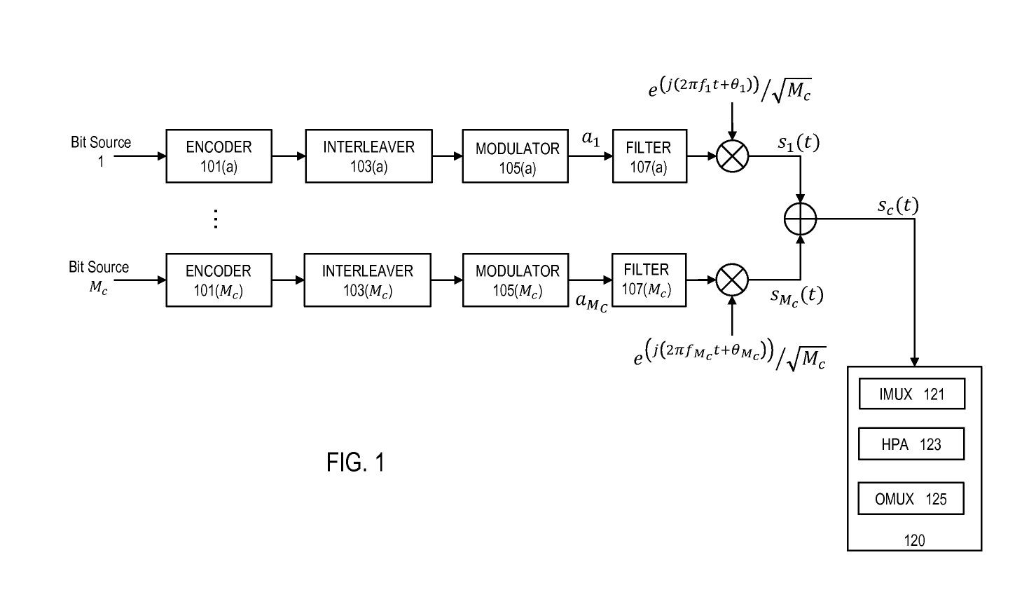

FIG. 1 illustrates a block diagram depicting a transmitter in a multicarrier system, where M_{c} independent source signals are to be transmitted over a single satellite channel. Each independent bit source, 1, . . . , M_{c}, is FEC encoded via the respective encoder 101(a), . . . , 101(M_{c}), interleaved via the respective interleaver 103(a), . . . , 103(M_{c}), and mapped onto a two dimensional M−ary constellation (e.g., QPSK, 8 PSK, 16 APSK., etc.) by the respective modulator 105(a), . . . , 105(M_{c}). The resulting signals, a₁, . . . , a_{M}_{_{c}}, reflect the complex-valued symbol sequences {a_{m,k}; k=0, 1, . . . , N−1; m=1, 2, . . . , M_{c}} at the symbol rate Tₛ⁻¹. The resulting symbol sequences are processed by the respective pulse-shaping filters 107(a), . . . , 107(M_{c}) with respective impulse responses p_{1,T}(t), . . . , p_{M}_{_{c}}_{,T}(t) to generate the respective baseband modulated signals:

$${s}_{m} ( t ) = {\sum }_{k} {a}_{m , k} \cdot {p}_{m , T} ( t - {kT}_{s} ) \qquad ( 1 )$$

Where Tₛ is the symbol period.

Each signal is then frequency-translated to its respective slot or center frequency and combined, where the composite signal can then be described as:

$${s}_{c} ( t ) = {\sum }_{k} {s}_{m} ( t ) \frac{exp ( j ( 2 π {f}_{m} t + {θ}_{m} ) )}{\sqrt{{M}_{c}}} \qquad ( 2 )$$

where fₘ and θₘ are the center frequency and carrier phase of the m^{th} channel, respectively.

The signal composite of equation (2) is then processed by the satellite transponder 120, which includes an input multiplexing (IMUX) filter 121, a nonlinear traveling wave tube amplifier (TWTA) or high power amplifier (HPA) 123, and an output multiplexing (OMUX) filter 125. The IMUX filter selects the desired group of M_{c} carriers, thereby limiting the impact of adjacent uplink carriers. The OMUX filter follows the TWTA and is used to limit nonlinear interference to adjacent transponders. The frequency response associated with the IMUX and OMUX are obtained by using a scaling formula of the corresponding filter responses with a scale factor of M_{c}, or

$$\begin{matrix}{R}^{′} ( f ) = R ( f / {M}_{c} ) & ( 3 ) \\ {G}^{′} ( f ) = \frac{1}{{M}_{c}} \cdot G ( f / {M}_{c} ) & ( 4 )\end{matrix}$$

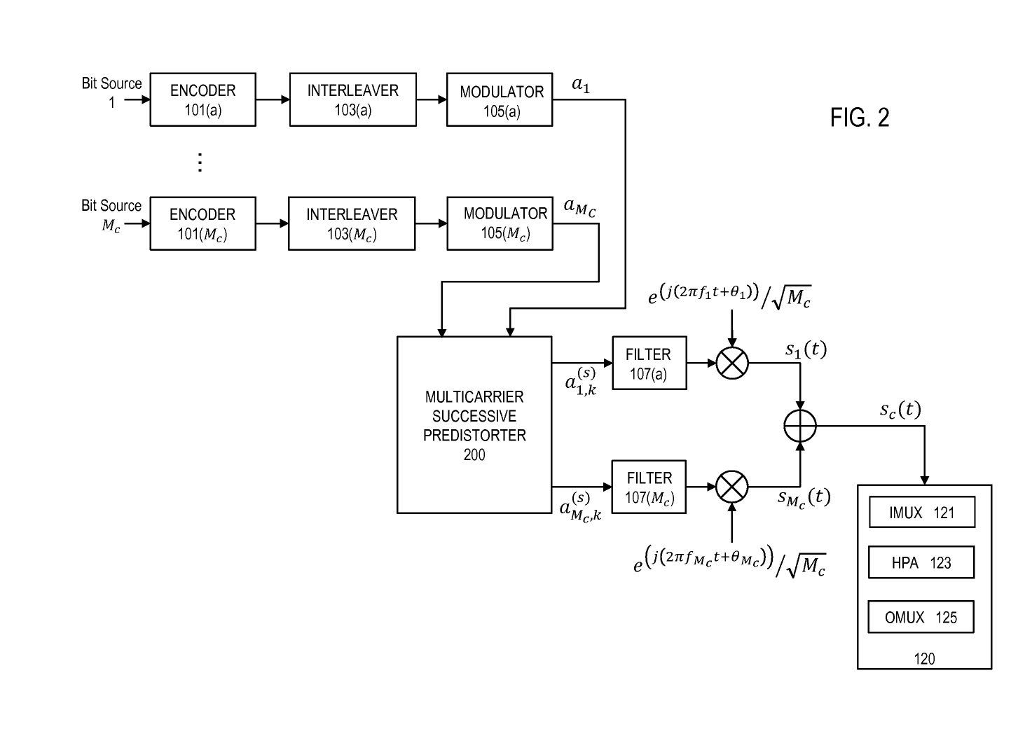

FIG. 2 illustrates a block diagram depicting the multicarrier transmitter of FIG. 1, employing a multicarrier predistorter, in accordance with example embodiments of the present invention. With reference to FIG. 2, the like numbered blocks perform the same functions, and thus the associated description will not be repeated here. The multicarrier transmitter of FIG. 2 includes the multicarrier successive predistorter 200, which predistorts the signal sequences via successive stages. The complex-valued symbol sequences output from the modulators 105(a), . . . , 105(M_{c}), {a_{m,k}; k=0, 1, . . . , N−1; m=1, 2, . . . , M_{c}}, are fed into the multicarrier predistorter, and the output of the successive predistorter (with S stages) is given by {am,k^{(s)}; k=0, 1, . . . , N−1; m=1, 2, . . . , M_{c}}, which is also at the symbol rate Tₛ⁻¹.

By way of example, for discussion purposes, an 8-symbol phrase a₀a₁a₂a₃a₄a₅a₆a₇ is to be transmitted. The 8-symbol phrase is referred to as the ideal phrase, such that, in an ideal communications system, a receiver would receive the same 8-symbol phrase, undistorted. As a result of distortions, including inter-symbol interference (ISI) and adjacent channel interference (ACI), a receiver would receive a distorted form the eight symbols of the ideal 8-symbol phrase.

In accordance with an example embodiment of the present invention, ISI is addressed by using N stages of predistortion. For example, for N=2 there are two stages of predistortion. Each symbol in the 8-symbol phrase will be adjusted by subtracting a calculated predistortion from the signal. The predistortion is calculated for the first stage by way of a predistorter by using the current symbol in addition to past and future symbols to be transmitted on a single channel to calculate a distortion estimate that is removed from the ideal current symbol to be output. For example, the predistortion of symbol a₅, referred to as ã₅, will be determined based on a₅ and an estimated predistortion of each of symbols a₀a₁a₂a₃a₄a₅a₆a₇. Subsequent stages of the predistorter take the estimated output for the current symbol as well as the estimated output for past and future symbols from the previous stage to calculate a new distortion estimate for the current symbol. The new distortion estimate is then subtracted from the ideal current symbol to create a new estimated output. For example, the second stage predistortion of symbol a₅, referred to as ã′ₛ, will be determined based on a₅, and an estimated predistortion of each of symbols a₀a₁a₂a₃a₄a₅a₆a₇, and the first stage predistortion of symbol a₅, referred to as ã₅.

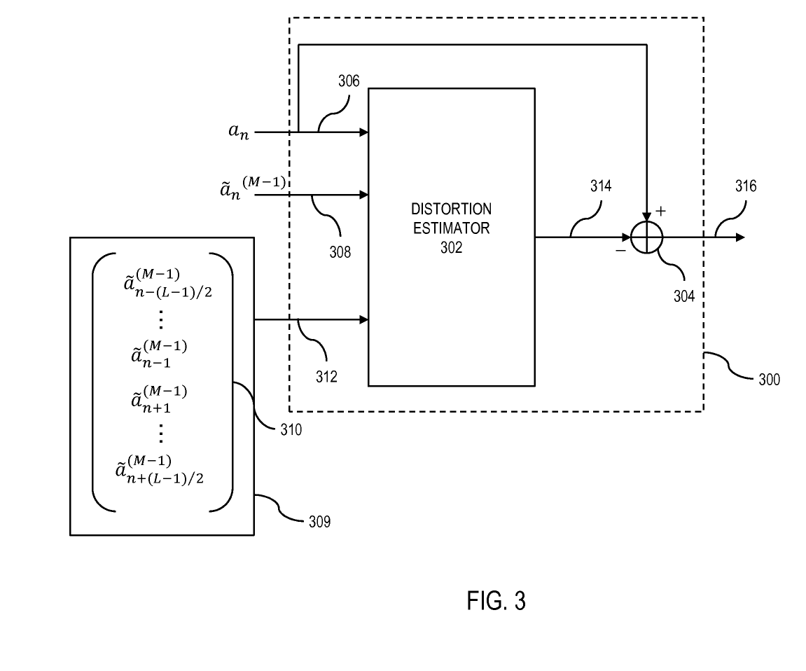

FIG. 3 illustrates a block diagram depicting an M^{th} stage of the multicarrier successive predistorter 200 of FIG. 2, for a one of the M_{c} signals, in accordance with example embodiments of the present invention. The M^{th} stage predistorter 300 includes a distortion estimator 302, an inter-symbol distortion estimating unit 309 and a subtractor 304. M^{th} stage predistorter 300 takes as input undistorted symbol 306, distorted (M−1)^{th} symbol 308 and distorted symbol vector 312. Distorted (M−1)^{th} symbol 308 is the (M−1)^{th} stage of predistorted version of undistorted symbol 306. The inter-symbol distortion estimating unit creates a distorted symbol vector 312 that is comprised of distorted (M−1)^{th} vector 310, the (M−1)^{th} stage predistorted versions of (L−1)/2 past and (L−1)/2 future symbols.

Distortion estimator 302 takes as input undistorted symbol 306, distorted (M−1)^{th} symbol 308 and distorted symbol vector 312 to calculate distortion estimate 314. Subtractor 304 removes distortion estimate 314 from undistorted symbol 306 to create distorted output 316. By increasing the number of predistortion stages, the predistortion of a symbol will approach the inverse of the actual distortion the symbol may encounter. This will increase the likelihood that a receiver will receive the ideal symbol. However, increasing the number of predistortion stages increases the processing power of the transmitter. FIG. 10 illustrates an example predistorter 204A including multistage predistortion using N states of predistortion where N=2, showing a first stage of predistortion 300A and a second stage of predistortion 300B. Distortion estimator 302, inter-symbol distortion estimating unit 309 and subtractor 304 are indicated as distinct items. In some embodiments, at least two of distortion estimator 302, inter-symbol distortion estimating unit 309 and subtractor 304 may be combined as a unitary item.

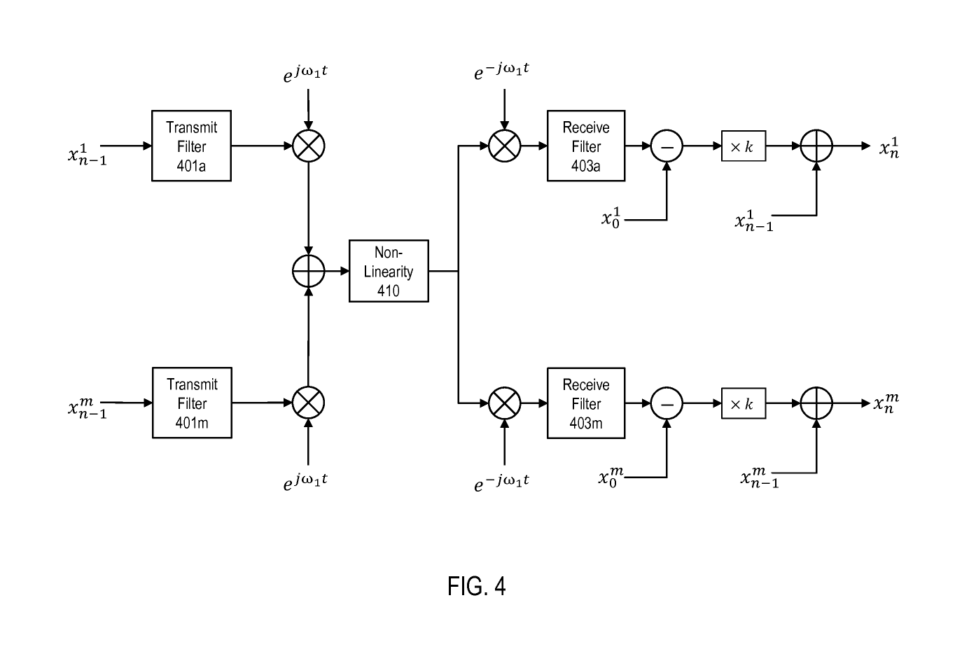

FIG. 4 illustrates a block diagram depicting a multicarrier dynamic predistorter, in accordance with example embodiments of the present invention. The Figure illustrates a single stage of an iterative predistortion algorithm, as applied to a multicarrier transmission (e.g., a transmission via a single nonlinear amplifier, such as in a frequency multiplexed (FDM) manner), in accordance with example embodiments of the present invention. In a multicarrier system, multiple source signals may be transmitted via a common nonlinear amplifier, each on a different frequency transmission carrier. In such a multicarrier system, the multiple source signals (xₙ₋₁¹, xₙ₋₁², . . . , xₙ₋₁^{m}) are passed through a common nonlinearity model 410. While the figure illustrates just two such carriers, the embodiments of the present invention are not so limited, and may comprise any number of multiple carrier signals, where n indicates the number of the predistortion iteration (with iteration 0 being the original input), and m indicates an index of the FDM carrier (where the frequency of the respective carrier m is ωₘ radian/sec). By way of example, each of the multiple FDM transmit signals (xₙ₋₁¹, xₙ₋₁², . . . , xₙ₋₁^{m}) is first passed through a respective transmit filter model, and then the resulting individual filtered signals are summed at the nonlinearity input. Then, after translating the signal frequency of the nonlinearity output back to the baseband of each respective carrier, a distortion is computed independently for each carrier and used to independently modify the input sequence for each carrier. Then, the resulting translated signal for each carrier is passed through a receive filter model, and the output is subtracted from the source input signal for the current iteration—where the result of the subtraction reflects an error sequence. Then, for each carrier, some fraction (k) of this error is added to the predistorted input, resulting in a new sequence that serves as the predistorted signal input for the next iteration for the respective carrier. Again, the iterations of the algorithm can then be repeated, where the error decreases with each iteration, and the number of iterations is based on a tradeoff between complexity versus the relative improvement achieved by each successive iteration.

A more detailed description of a communication system in accordance with aspects of the present invention will now be provided. For the following description, it is assumed that the composite signal s_{c}(t), is transmitted via the satellite transponder 120, where the HPA 123 operating at or near saturation. For purposes of the following description, the transmitted signal is reflected as r(t) and the received signal at the receiver is reflected as r(t).

The received signal r(t) and associated noise, is

r(t)=s(t)+n(t) (1)

Noise n(t) is assumed as standard Additive White Gaussian Noise (AWGN) with single-sided Power Spectral Density (PSD) level of N₀ (Watts/Hz). Output signal s(t) 144 includes N adjacent channels within a satellite transponder; each is transmitting at the rate of Tₛ⁻¹ with an arbitrary unit-energy pulse p(t). The signal can be described in baseband format as

s(t)=Re{\tilde{s}(t)e^{j2πf}^{_{c}}^{t}} (2)

where f_{c} is the carrier frequency and \tilde{s}(t) is the baseband complex envelope of the signal and is mathematically expressed as

$$s ( t ) = {\sum }_{n = - ( N - 1 ) / 2}^{( N - 1 ) / 2} {\tilde{s}}_{HL , n} ( t ) \cdot {α}_{n} \cdot exp ( j \cdot 2 \cdot π \cdot Δ {f}_{n} t + {θ}_{n} ) \qquad ( 3 )$$

where N is assumed as an odd integer without loss in generality. The center channel conveys the desired data and the other signals are viewed as being adjacent channel interferers, (N−1)/2 on either side. In practical systems the channels are equally spaced in frequency, say by Δf, or

$$Δ {f}_{n} = ( n - \frac{N + 1}{2} ) \cdot Δ f ; \\ n = 1 , 2 , … , N \qquad ( 4 )$$

In accordance with an aspect of the present invention, ISI and ACI filtering techniques are of importance when channel frequency spacing is small enough to cause large amount of overlap in signal spectra. Smaller channel spacing translates into higher bandwidth efficiency. The bandwidth efficiency, η, in bits-per-second/Hz is defined as the ratio of the bit rate to the bandwidth used or

$$η = \frac{{log}_{2} ( M )}{Δ f \cdot {T}_{s}} \qquad ( 5 )$$

where M is the order of the modulation or the alphabet size. The n^{th} channel signal, for example the channel providing signal 130 of FIG. 1, includes hard-limiter (HL) 212 to ensure a constant envelope. In other words, there is a constant amplitude in the signal within the channel. The signal can be described mathematically as

\tilde{s}_{HL,n}(t)=exp(j·Φ_{s,n}(t)) (6)

where Φ_{s,n}(t) is the phase of the complex-valued signal stream \tilde{s}ₙ(t), for example signal 222 of FIG. 2, and is given by

$${\tilde{s}}_{n} ( t ) = {\sum }_{k} {a}_{n , k} \cdot p ( t - {KT}_{s} - {ɛ}_{n} {T}_{s} ) \qquad ( 7 )$$

Another implementation of hard-limiter 212 is

$${\tilde{s}}_{HL , n} ( t ) = \frac{{\tilde{s}}_{n} ( t )}{\vert {\tilde{s}}_{n} ( t ) \vert} \qquad ( 8 )$$

Signal \tilde{s}_{HL,n}(t), for example signal 130 at the output of hard-limiter 212 as illustrated in FIG. 2, has exact constant envelope and hence does not suffer from additional distortions introduced by saturated power amplifiers.

To illustrate the capability of the present invention, the data streams a_{n,k}; n=−(N−1/2), . . . , (N−1/2) consist of π/8−8 PSK symbols. However, any other modulation format can benefit from this invention. Other modulations such as standard QPSK, MPSK, M−QAM, or their offset variations can also be used.

For standard MASK, the symbols are uniformly distributed on the unit circle, or for the k^{th} K symbol in the n^{th} data stream, it is expressed as

$${a}_{n , k} ∈ \{ exp ( \sqrt{- 1} \cdot ( \frac{( i - 1 ) \cdot π}{M} + \frac{π}{M} ) ) ; i = 1 , 2 , … , M \} \qquad ( 9 )$$

To generate π/M−MPSK, each symbol is further rotated by an additional π/M relative to the previous symbol. This rotation every symbol avoids phase transitions of 180 degrees between adjacent symbols that is experienced with the standard MPSK. This is preferable in the presence of non-linear characteristics in practical systems.

Multistage predistortion implemented at the transmitter in accordance with the present invention, for example as discussed above with reference to FIG. 3, shall now be described in mathematical detail.

To compensate for the non-linear ISI that is present due to the hard-limiter 212 or the non-linear characteristic of the saturated HPA 226, multistage predistortion with total memory of L symbols is introduced. This method entails estimating the distortion that would result from passing the current symbol 306, distorted (M−1)^{th} vector 310 (including the (M−1)^{th} stage predistorted versions of (L−1)/2 past and (L−1)/2 future symbols) through the cascade of transmitter filter 210, hard-limiter 212 and receiver filter 406. This distortion estimate 314 is then subtracted from the current symbol 306 at the modulator before transmission.

For progressively improved performance, this predistortion method is applied repeatedly. Here, the distortion estimate is generated by passing the current predistorted symbol, (L−1)/2 previous predistorted symbols and (L−1)/2 future predistorted symbols through the cascade of transmitter filter, hard-limiter and receiver filter. This improved distortion estimate is then subtracted from the current symbol at the modulator before transmission.

More specifically, for the first stage of predistortion, the effect of the transmitter filter on the current symbol and its adjacent symbols for the m^{th} channel is computed as

$${a}_{L , m , k} ( t ) = {\sum }_{i = k - ( L - 1 ) / 2}^{k + ( L - 1 ) / 2} {a}_{m , i} \cdot p ( t - i {T}_{s} ) \qquad ( 10 )$$

Next, the effect of hard-limiter 212 on the result by decomposing a_{L,m,k}(t) into amplitude and phase is computed as

a_{L,m,k}(t)=|α_{L,m,k}(t)|·exp(j·Φ_{α,m,k}(t)) (11)

Then output 130 of hard-limiter 212 is computed as

$$\begin{matrix}{β}_{L , m , k} ( t ) = exp ( j \cdot {Φ}_{α , m , k} ( t ) ) \\ or & ( 12 ) \\ {β}_{L , m , k} ( t ) = \frac{{α}_{L , m , k} ( t )}{\vert {α}_{L , m , k} ( t ) \vert} & ( 13 )\end{matrix}$$

To incorporate the effect of the complete cascade, the impact of receiver filter 406 on β_{L,m,k}(t) is computed as

xₘ(t)=∫β_{L,m,k}(t)·p*(τ−t)·dτ (14)

The distortion estimate, for example signal 314 of FIG. 3, of the first stage for the m^{th} channel is computed as

d_{L,m,k}⁽¹⁾=xₘ(k·Tₛ) (15)

The last step is to subtract this distortion estimate from the current symbol, for example item 306 of FIG. 3, to produce the 1^{st} stage predistorted symbol with memory L for the m^{th} channel, ã_{L,m,k}⁽¹⁾, or

a_{L,m,k}⁽¹⁾=a_{m,k}−d_{L,m,k}⁽¹⁾·λ₁ (16)

where Δ₁ is a scale factor to set the amount of residual distortion and is typically chosen as unity.

The steps to generate the s-stage predistorted symbol 316 are similar, except that one starts with the predistorted symbols 312 from the (s−1) stage as

$${α}_{L , m , k}^{( s )} ( t ) = {\sum }_{i = k - ( L - 1 ) / 2}^{k + ( L - 1 ) / 2} {\tilde{a}}_{L , m , i}^{( s - 1 )} \cdot p ( t - i {T}_{s} ) \qquad ( 17 )$$

Next, the effect of hard-limiter 212 on the result is computed by decomposing α_{L,m,k}^{(s)}(t) into amplitude and phase as

α_{L,m,k}^{(s)}(t)=|α_{L,m,k}^{(s)}(t)|·exp(j·Φ_{L,m,k}^{(s)}(t)) (18)

Then output 130 of hard-limiter 212 is computed as

$$\begin{matrix}{β}_{L , m , k}^{( s )} ( t ) = exp ( j \cdot {Φ}_{α , m , k}^{( s )} ( t ) ) \\ or & ( 19 ) \\ {β}_{L , m , k}^{( s )} ( t ) = \frac{{α}_{L , m , k}^{( s )} ( t )}{\vert {α}_{L , m , k}^{( s )} ( t ) \vert} & ( 20 )\end{matrix}$$

To incorporate the effect of the complete cascade, the impact of receiver filter 406 on β_{L,m,k}^{(s)}(t) is computed as

xₘ^{(s)}=∫β_{L,m,k}^{(s)}(τ)·p*(τ·t)·dτ (21)

The distortion estimate, for example item 314 of FIG. 3, of the s^{th} stage for the m^{th} channel is computed as

d_{L,m,k}^{(s)}=xₘ^{(s)}(k·Tₛ) (22)

The last step is to subtract distortion estimate 314 from current symbol 306 to produce the s^{th} stage predistorted symbol 316 with memory L for the m^{th} channel, ã_{L,m,k}^{(s)}, or

ã_{L,m,k}^{(s)}=a_{m,k}−d_{L,m,k}^{(s)}λₛ (23)

where λₛ is a scale factor to set the amount of residual distortion and is typically chosen as unity.

Noteworthy in this respect is that the proposed implementation computes the distortion estimate d_{L,m,k}^{(s)} on the fly. Another implementation is possible that may include a RAM to prestore a lookup table, which is addressed by the symbols within the span of the predistorter memory. This table-based implementation is less preferred in the case of sending higher-order modulations as the table size can grow very large, very quickly. For example, for π/M−MPSK modulation, the required table size is M^{L} where L is the memory span. This table size can be reduced by exploiting constellation symmetry but still would be large when using large alphabet size required for maximizing data throughput.

In addition, a memory-less predistorter is a special case of the proposed scheme, which results when the memory span of the predistorter is set to one. Memory-less predistortion can help only with the warping effect but is not capable of reducing the amount of clustering due to ISI that is experienced here.

According to an aspect of the invention, receiver 400 uses an interference canceller 412 coupled with use of predistorter 204 at transmitter 100. Interference cancellation with predistortion will now be described in more detail.

As stated previously, the major drawback to the hard-limiter or the non-linear characteristic of saturated HPA 226 is the spectral regrowth. This coupled with the need to maximize the efficient utilization of bandwidth causes severe interference. In accordance with an aspect of the present invention, subtractive interference cancellation with multistage predistortion is used to compensate for the ISI resulting from the non-linear distortion and more importantly the ACI when using multiple carriers within a satellite transponder. The method entails estimating the ACI that would result from passing the estimated symbols from adjacent channels through the cascade of transmitter filter of adjacent channels, hard-limiter and receive filter at the desired channel. This interference estimate is then subtracted from the matched-filter bank at the receiver before making a decision on which symbol was transmitted.

Other optimization techniques can also be used to arrive at the predistorted constellation. The method of computing multistage predistortion outlined above will now be describe in greater detail.

More specifically, to estimate the interference from m′^{th} channel on the desired m^{th} channel, the symbols from the m′^{th} channel are first estimated as

â_{m′,n}=Decision(xₘ,(nTₛ)) (24)

where x_{m′} is the matched filter at the m′^{th} channel. More on the decision device Decision(z) will be described below.

Multistage predistortion in accordance with an aspect of the present invention as discussed above is then applied to generate the s^{th} stage predistorted symbol with memory L for the m′^{th} channel, ã_{L,m,k}^{(s)}. To compute the effect of the transmitter filter on the estimated predistorted symbols, the method implements

$${η}_{{m}^{′}} ( t ) = [ {\sum }_{n} {\tilde{a}}_{L , {m}^{′} , k}^{( s )} \cdot p ( t - {nT}_{s} ) ] \qquad ( 25 )$$

Next, the effect of hard-limiter 212 on the result is computed by decomposing η_{m′}(t) into amplitude and phase as

η_{m′}=|η_{m′}(t)|·exp(j·Φ_{η,m′}(t)) (26)

Then, output 130 of hard-limiter 212 is computed as

$$\begin{matrix}{μ}_{{m}^{′}} ( t ) = exp ( j \cdot {Φ}_{η , {m}^{′}} ( t ) ) \\ or & ( 27 ) \\ {μ}_{{m}^{′}} ( t ) = \frac{{η}_{{m}^{′}} ( t )}{\vert {η}_{{m}^{′}} ( t ) \vert} & ( 28 )\end{matrix}$$

To incorporate the effect of the complete cascade, the impact of the receiver filter on μ_{m′}(t) as well as the channel spacing, for example signal 424 as illustrated in FIG. 4, is given by

ξ_{m′,m}(t)=∫μ_{m′}(τ)·exp(−j2π·(Δfₘ−Δf_{m′})·τ)·p*(τ−t)·dτ (29)

The interference estimate for the m^{th} channel using (M_{I}−1)/2 adjacent channels on either side is computed as

$${I}_{m , k}^{( {M}_{1} )} = {\sum }_{i = - ( {M}_{1} - 1 ) / 2}^{( {M}_{1} - 1 ) / 2} {α}_{m - i} \cdot {ξ}_{m - 1 , m} ( {kT}_{s} ) ; \\ i \neq 0 \qquad ( 30 )$$

where αₘ is related to the power level of the m^{th} channel.

The last step is to subtract this interference estimate from the current matched filter output before applying the decision device to produce the desired symbol estimate, for example item 430 of FIG. 4, or

â_{m,k}^{(M}^{₁}⁾=Decision(xₘ(kTₛ)−I_{m,k}^{(M}^{₁}⁾·σ₁) (31)

where σ₁ is a scale factor to set the amount of residual interference and is typically chosen as unity.

The decision device D e cis ion(z) equations (24) and (31) can be any mapping function that produces estimates of the interfering symbols including, non-limiting examples of which include a soft-decision device that uses reliability information provided by the FEC decoder such as log-likelihood ratios one that does not use FEC decoder information and is therefore simpler to implement.

As mentioned previously that the use of 8 PSK modulation is only for illustrative purposes. The proposed techniques are effective with other modulations as well such as M−QAM and higher-order MPSK or their offset variations. Also, even though a hard-limiter is used at the transmitter to ensure constant envelope, the same techniques proposed here are effective when the hard-limiter is not incorporated or when the hard-limiter is replaced with HPA 226 with non-linear characteristics. Finally, there are other optimization techniques that can be employed to arrive at the predistorted constellation. Any of these techniques can be combined with interference cancellation to benefit from this invention.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The exemplary embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A method comprising:
receiving a plurality of source signals;
applying a transmit filter model to each of the source signals to generate a respective filtered signal for each source signal;
translating each of the filtered signals to a respective carrier frequency;
summing the translated signals to generate a composite signal;
applying a common non-linearity model to the composite signal to generate a model transmit signal;
translating the transmit signal to generate a receive signal estimate of each of the filtered signals;
applying a receive filter model to each of the receive signal estimates to generate a filtered receive signal estimate;
subtracting each filtered receive signal estimate from the respective source signal to generate an error sequence for the respective filtered receive signal estimate; and
adding a fraction of the error sequence for each filtered receive signal estimate to the respective source signal to generate a respective predistorted signal for transmission via a multicarrier satellite transponder.
